(19) United States
(12) Patent Application Publication
(10) Pub. No.: US 2016/0223153 A1
(43) Pub. Date: Aug. 4, 2016

(54) LUMINARY WITH A WIRELESS TRANSMITTER

(71) Applicant: PHILIPS LIGHTING HOLDING B.V., Eindhoven (NL)

(72) Inventors: NICO VAN DIJK, EINDHOVEN (NL); PETER FITSKI, HELMOND (NL); WILLEM FRANKE PASVEER, DORDRECHT (NL)

(21) Appl. No.: 14/913,800

(22) PCT Filed: Aug. 18, 2014
(86) PCT No.: PCT/EP2014/067601

§ 371 Date: Feb. 23, 2016

(30) Foreign Application Priority Data
Aug. 23, 2013 (EP) 13181607.6

(51) Int. Cl. F21S 8/04; H01Q 1/22; F21V 21/03; F21V 7/00; H05B 37/02

(52) U.S. Cl. CPC F21S 8/04; F21V 7/00; H05B 37/0272; F21V 21/03; H01Q 1/22

(57) ABSTRACT

A luminary (1) configured for attachment to a ceiling of a space to be illuminated comprises a casing, a fixture for securing a lighting component to the casing, a wireless transmitter module comprising an antenna (10) located in the casing, and a securing component arranged to secure the luminary with respect to a ceiling plate (20). The securing component may be configured to space the casing from the ceiling plate (20) to provide an air-gap (22) between the casing the ceiling plate (20), whereby the casing constitutes a resonant cavity for RF energy transmitted from the antenna (10), the air-gap being dimensioned to radiate RF energy from the antenna (10) to the environment externally of the casing.

### FIELD

The present invention relates to a luminary which incorporates a wireless transmitter.

### BACKGROUND

Luminaries (or luminaires) constitute a basic component of many lighting solutions, particularly intelligent lighting solutions incorporating light emitting diode (LED) lighting. Another important component of intelligent lighting systems is control modules which are equipped with a radio and antenna to provide wireless connectivity. The control modules operate in a communication mesh, where each module constitutes a node of the mesh. Presently, control modules are often integrated in luminaries. Luminaries are typically manufactured with metal and plastic materials. In particular, any metal parts can have a high impact on the radiation properties of the antenna. The quality of the communication (propagation distance and package error rate (PER)) within the mesh depends very much on the radiation properties of the antenna as integrated into the illumination system.

Currently, specifically designed gaps and holes are provided in the luminaries in order to enable electromagnetic energy to propagate properly to the environment.

An alternative solution to the provision of gaps and holes is to provide external (e.g. patch) antennas on an outer surface of the luminary. Such external antennas are expensive.

### SUMMARY

According to one aspect of the invention there is provided a luminary configured for attachment to a ceiling of a space to be illuminated, the luminary comprising: a casing; a fixture for securing a lighting component to the casing: a wireless transmitter module comprising an antenna located in the casing; and

a securing component arranged to secure the luminary with respect to a ceiling plate and configured to space the casing from the ceiling plate to provide an air-gap between the casing and the ceiling plate, whereby the casing constitutes a resonant cavity for RF energy transmitted from the antenna, the air-gap dimensioned to radiate RF energy from the antenna to the environment externally of the casing.

Another aspect of the invention provides an illumination system configured for attachment to a ceiling of a space to be illuminated, the illumination system comprising: at least one luminary as hereinabove defined, and a ceiling plate secured to the luminary by the securing component.

The illumination system can comprise multiple luminaries spaced apart in an array, each luminary being as hereinabove defined and intended to communicate with each other through the radiation of RF energy from their respective antennas.

For a better understanding of the present invention and to show how the same may be carried into effect, reference will now be made by way of example to the accompanying drawings.

### BRIEF DESCRIPTION OF THE DRAWINGS

FIG. 1 is a schematic perspective view of an illumination system;

FIG. 2 is a schematic view of a transmitter module;

FIG. 3 is a schematic plan view of a radiation pattern;

FIG. 4 is a schematic block diagram of an illumination system seen from below;

FIG. 5 is a schematic perspective view of a luminary casing operating as a resonant cavity;

FIG. 6A is a schematic view of the radiation pattern in 3D;

FIG. 6B is a schematic view of the radiation pattern from the side.

### DESCRIPTION OF THE PREFERRED EMBODIMENTS

In the present disclosure, an air-gap is used between a metal luminary and a metal ceiling plate on which the luminary is installed. The inventors have noticed that the use of an air-gap between the metal luminary and the ceiling plate results in better radiation properties than by using holes in the luminary itself. Moreover, efficient radiation properties can be achieved without the need for such holes in the luminaries, and also without having to resort to external antennas which can be expensive. It is advantageous to avoid the use of holes in the external walls of the luminaries, because holes require additional production steps to manufacture, and additional measures for safety requirements in use.

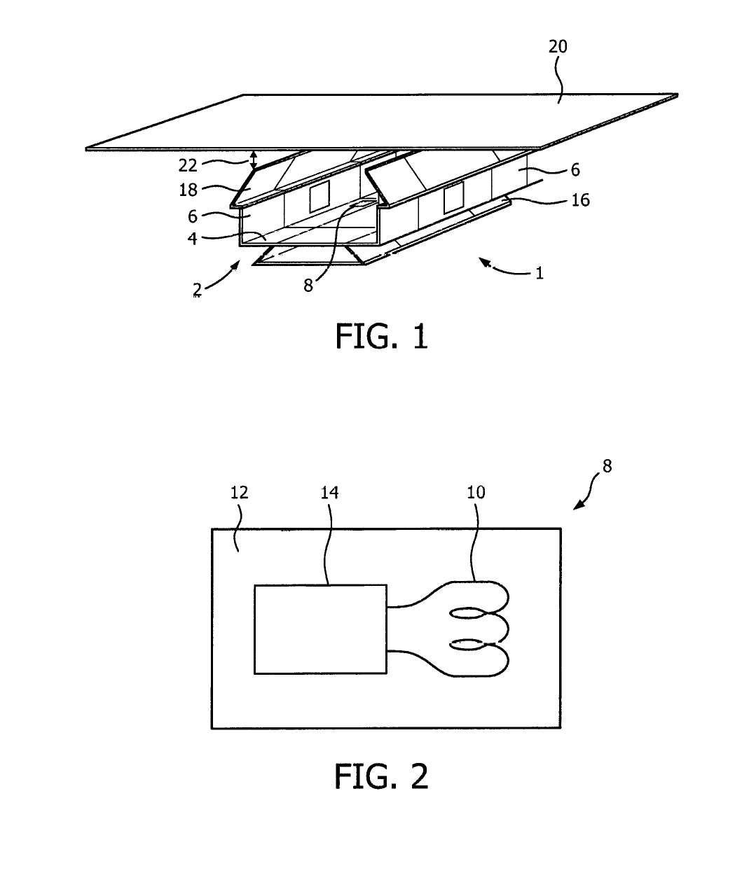

FIG. 1 is a schematic block diagram of an embodiment. FIG. 1 shows a single luminary made of any appropriate material, but typically of metal. The luminary of this embodiment is a so-called metal gear-tray luminary. The luminary 1 comprises a channel 2 of rectangular cross-section having a solid base 4 and solid side walls 6. A control module 8 is positioned inside the luminary on the base 4. The control module 8 comprises an antenna 10 placed on an RF board 12 (FIG. 2). The antenna 10 is connected to an RF generator component 14 which generates RF energy to provide control signals which are to be transmitted from the module 8. The RF generator 14 incorporates a controller or responds to a controller to determine the control signals to be generated, in a manner which is known per se and not described further herein. The control signals are intended to be received by other control modules in an illumination system as described more fully herein.

The luminary 1 has a reflector 16 secured to the underside of the base, with sloping walls having a reflective material on their inner side.

The luminary 1 is equipped with at least one lighting component secured to the underside of the base 4 using one or more suitable fixture, such that the lighting component emits light to be reflected downwardly by the reflector. The lighting components can be arranged to be under the control of the control signals which are exchanged between luminaries of the system, via a control module at each luminary.

The rectangular channel is provided at each upper edge by longitudinally extending portions which support inwardly angled walls 18. The side wall 6, the longitudinally extending portions and the inwardly angled walls 18 are all solid, that is they are formed of a continuous material, without gaps or holes. It is understood in this context that there may be matters of construction which have led for example, to screw holes or other fixtures and fittings to be inserted into the luminary, but there are no specially designed gaps and holes for the purposes of radiation emission.

The luminary is provided with a securing component (not shown) which secures the luminary 1 with respect to a ceiling plate 20, for example, of metal. The ceiling plate 20 is a substantially planar continuous sheet of material, for example, metal, secured to the ceiling or forming part of the ceiling. The luminary can be secured to the ceiling plate 20 itself, or to another part of the ceiling such that it is secured with respect to the ceiling plate. Either way, an air-gap 22 is formed between the upper edge of the inwardly directed walls 18 of the luminary channel and the lower surface of the ceiling plate 20.

As mentioned, the inventors have noted that the use of an air-gap between the metal luminary and ceiling plate results in better radiation properties than by using holes in the luminary itself. Besides the positive effect that this air-gap enables the electromagnetic energy radiated from the antenna 10 to radiate efficiently to the environment, use of the air-gap also provides a radiation pattern with useful directivity properties.

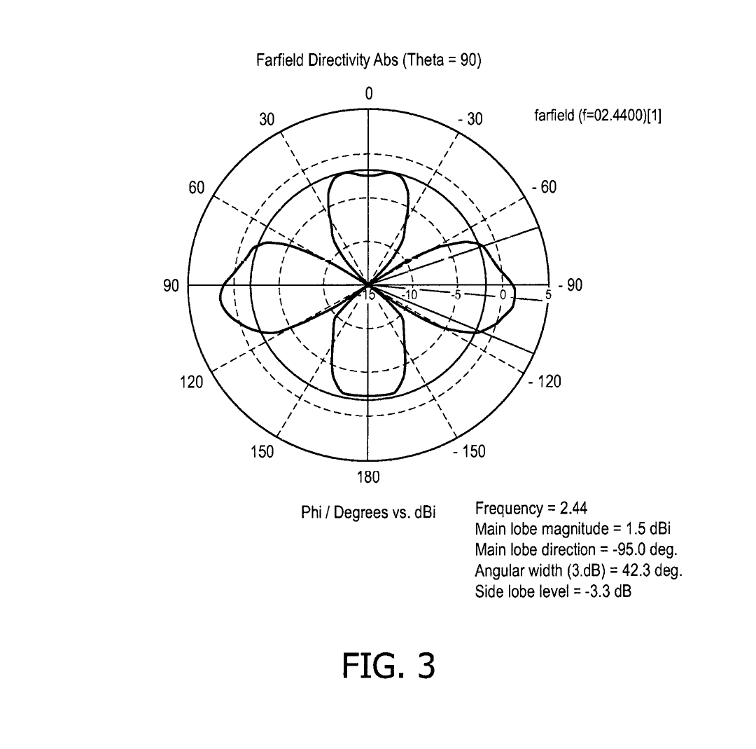

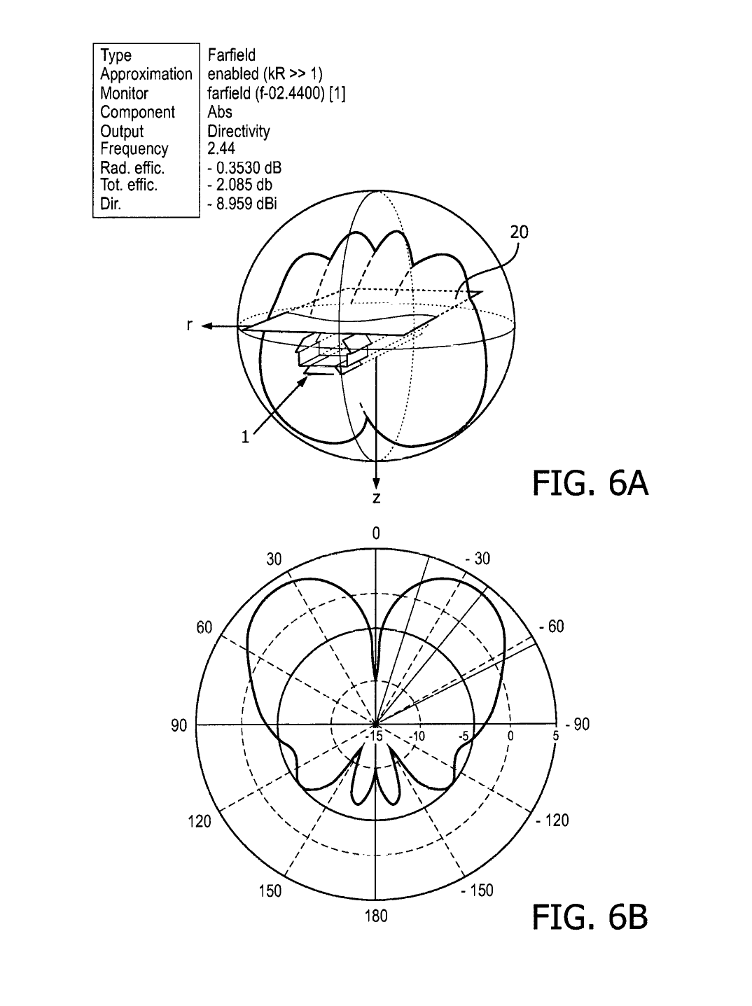

FIG. 3 shows the radiation pattern from a top down view of a radiation structure in the luminary of FIG. 1. The pattern of FIG. 3 assumes that the antenna 10 is located in the base to emit RF radiation in a direction substantially along the length of the rectangular channel, for example, away from the viewer in FIG. 1. Viewed from the side, the radiation pattern has downward lobes. This is also beneficial since it enables devices below ceiling level to receive RF signals from the luminary. See FIGS. 6A and 6B which show the radiation pattern in 3D and 2D respectively (from the side).

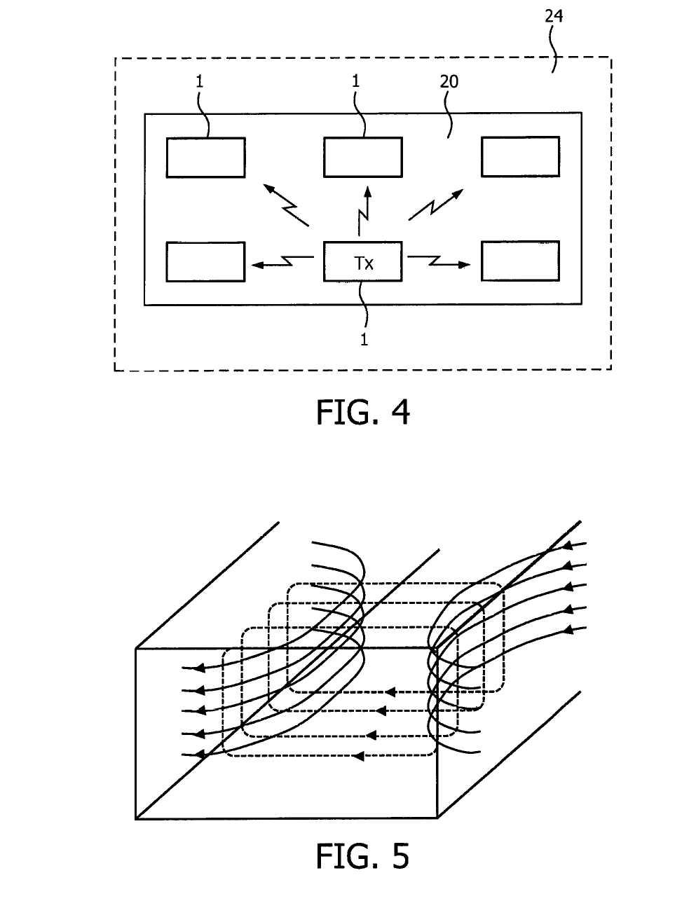

FIG. 3 shows the radiation pattern from above. It is a substantially cruciform pattern which is ideal for luminaries which are positioned in a rectangular array. This is particularly relevant for lighting solutions where the luminaries are configured in array grids, for example, in offices or parking garages. An example is shown in FIG. 4, which shows the underside of an illumination system in which an array of luminaries 1 are shown secured to the underside of a ceiling plate 20, which is itself shown with respect to the ceiling 24. The luminary marked TX is shown radiating, with the intention that signals radiated from the luminary 1 marked TX will be picked up by the other luminaries in the array. Thus, the cruciform radiation pattern of FIG. 3 is particularly appropriate to achieve this, and also represents an efficient solution.

In FIG. 4, each luminary can comprise a control module as described above in relation to FIG. 1. The control modules operate in a communication mesh, where each module constitutes a node of the mesh. This allows the luminaries to communicate with one another and to control the lighting levels. The quality of the communication (propagation distance and package error rate) within the mesh is much improved by the efficient radiation pattern obtained by use of the air-gap.

The material of the ceiling 24 can be either metal or concrete, and by use of a metal ceiling plate both situations can be coped with. The air-gap principle works particularly well for luminaries shaped as shown in FIG. 1 with a rectangular channel gear-tray. However, it is also applicable for other types of luminaries, as will be evident from the following description.

The mechanism of the air-gap concept is based on a resonant cavity. The metal channel 2 of the luminary 1 forms, with the ceiling plate 20, a resonant cavity. The control module 8 including the antenna 10 is a source of RF energy inside the cavity and the energy is distributed according to a transversal magnetic (TM) field pattern over the casing as shown in FIG. 5. The dotted lines indicate the magnetic field lines, which correspond to the surface currents. Subsequently, when an air-gap is applied as proposed above, then these surface currents are blocked and according to Faraday's law an induced voltage (and a corresponding electric field) will occur within the aperture created by the air-gap. The bold lines indicate electric field lines. The air-gap operates as a type of slot/aperture antenna to augment the wire antenna 10 which has generated the RF energy from the control module 8. The aperture 22 is excited from the inside energy and radiates the energy to the outside of the casing formed by the wall 6 and base 4. The air-gap can be suitable dimensioned for any size of luminary structure taking into account the wavelength of radiation and the casing characteristics. In one example, it has been shown that a minimum of 3 mm provides particularly effective radiation in combination with an optimal radiation pattern when used with the gear-tray luminary shown in FIG. 1 and the array of FIG. 4.

However, as the concept is based on a resonant cavity, the exact shape of the luminary and the location of the control module 8 within the luminary are not critical for the efficiency of radiation as long as the typical field distribution (TM) remains dominant. This should be the case as long as the luminary cross-section does not exceed a few (≈1 to 4) wavelengths of the emitted radiation. For example, with the 2.4 GHz ISM band (wavelength =12.5 cm), the cross-section should be smaller than 15 to 50 cm.

The radiation pattern can be slightly influenced by the longitudinal positioning of the transmitter module in the luminary, but this does not have a negative impact on the radiation efficiency nor on the gear-tray communication mesh performance. Moreover, the length of the luminary can have an effect on the radiation pattern, but nevertheless the overall advantages remain.

The unique benefit of the concept of using an air-gap between a metal luminary and a metal ceiling plate is that it combines an efficient pathway for the electromagnetic energy to the environment (including the nodes of the connectivity mesh) as well as directivity properties which are optimal for luminaries placed in an arrayed grid such as in offices and parking garages. Especially for metal gear-tray-types of luminaries, the air-gap principle is very effective for achieving excellent radiation properties. Moreover, it prevents additional measures in the luminary, such as holes, as well as the use of external antennas, resulting in a cost-effective solution.

Other variations to the disclosed embodiments can be understood and effected by those skilled in the art in practice of the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are cited in mutually different dependent claims does not indicate that a combination of these measures cannot be used to advantage. Any reference signs in the claims should not be construed as limiting the scope.

1. A luminary configured for attachment to a ceiling of a space to be illuminated, the luminary comprising:
a casing;
a fixture for securing a lighting component to the casing:
a wireless transmitter module arranged to transmit RE energy to another device, the wireless transmitter module comprising an antenna located in the casing, whereby the casing constitutes a resonant cavity for RF energy transmitted from the antenna; and
a securing component arranged to secure the luminary with respect to a ceiling plate and configured to space the casing from the ceiling plate to provide an air-gap between the casing and the ceiling plate, whereby the casing constitutes a resonant cavity for RF energy transmitted from the antenna, the air-gap dimensioned to radiate RF energy from the antenna to the environment externally of the casing.

2. A luminary according to claim 1, wherein the resonant cavity operates to distribute the RF energy according to a transversal magnetic mode field pattern within the casing.

3. A luminary according to claim 1, wherein the radiation pattern of the radiated RF energy is substantially cruciform in a plane substantially parallel to the ceiling plate.

4. A luminary according to claim 1, wherein the wireless transmitter module comprises an RF generator for generating control signals to be transmitted in the RF energy transmitted from the antenna.

5. A luminary according to claim 1, which comprises at least one lighting component secured to the fixture.

6. A luminary according to claim 1, wherein the casing comprises a solid base with upwardly extending solid walls.

7. A luminary according to claim 3, comprising a reflector extending downwardly from the base and outwardly of the casing.

8. A luminary according to claim 1, wherein the casing comprises a rectangular channel having a lower surface providing a base portion with upwardly extending wall portions, wherein the wireless transmitter module is secured to the lower surface, the antenna radiating RF energy in a direction along the channel.

9. A luminary according to claim 1, wherein the air-gap is at least 3 mm in depth.

10. A luminary according to claim 8, wherein the width of the rectangular channel is of the order of a few wavelengths of the radiation.

11. A luminary according to claim 3 wherein the radiation pattern has downward lobes when viewed from the side.

12. A luminary according to claim 8 wherein the upwardly extending wall portions are formed of a continuous material without gaps or holes.

13. An illumination system for securement to a ceiling of a space to be illuminated, the illumination system comprising:
a ceiling plate;
at least one luminary secured to the ceiling plate, the luminary comprising a casing and the luminary secured to the ceiling plate to space the casing from the ceiling plate to provide an air-gap between the casing and the ceiling plate, the luminary comprising a wireless transmitter module arranged to transmit RE energy to another device in the illumination system, the wireless transmitter module comprising an antenna located in the casing, and a fixture for securing a lighting component to the casing, whereby the casing constitutes a resonant cavity for RF energy transmitted from the antenna, and wherein the air-gap is dimensioned to radiate RF energy from the antenna to the environment externally of the casing.

14. A system according to claim 13, comprising multiple luminaries organized in an array and secured to the ceiling plate.

15. A system according to claim 14, wherein each luminary comprises a node in a mesh network constituted by the array, the luminaries arranged to communicate using control signals in the radiated RF energy.
